(19) United States
(12) Patent Application Publication
(10) Pub. No.: US 2016/0255765 A1
(43) Pub. Date: Sep. 8, 2016

(54) MANUALLY OPERATED SEED TRANSFERRING DEVICE

(71) Applicant: MARY LOUISA LIGON, ALMONT, MI (US)

(72) Inventor: MARY LOUISA LIGON, ALMONT, MI (US)

(21) Appl. No.: 14/639,150

(22) Filed: Mar. 5, 2015

(51) Int. Cl. A01C 7/04; B25J 1/00

(52) U.S. Cl. CPC A01C 7/04; B25J 1/00

(57) ABSTRACT

A manually operated seed transferring device that is portable, self-contained and simple to operate. The device consists of a barrel, a nib holder, and a nib. The barrel is hollow and acts as a reservoir for a liquid. The outside of the barrel is designed to be held comfortably in the fingers. The nib holder is attached to the barrel and is designed to hold the nib securely. The nib is of a material which absorbs liquids such as water which is conveyed from inside the barrel to the nib through capillary action and gravity. When the moist nib comes into contact with a seed the seed is attracted to the nib and can be transferred to a wet substrate such as moist planting media.

### FIELD OF THE INVENTION

The present invention relates to a seed transferring device and, more particularly, to one which is compact and manually operated.

### BACKGROUND OF THE INVENTION

In small nursery, greenhouse, home and research operations it is often necessary to pick up and transfer very small seeds to a moist growing medium. The small size of the seeds makes this a very time consuming and difficult task.

Some solutions to the problem have been to pick up and transfer each tiny seed using fingers, tweezers or a wet toothpick. Other solutions have been developed to automate the process using a variety of machines designed for the purpose.

Picking up tiny seeds by hand or using tweezers or a wet toothpick is arduous and requires a high amount of dexterity. Most human fingers are just too big and clumsy to pick up very small seeds and transfer them efficiently. Using tweezers to transfer small seed can damage the seeds by exerting too much pressure on them and for small hard seeds the seed can spray out of the grasp of the tweezers and become lost. Transferring small seeds using a wet toothpick requires frequent dipping which can be time consuming and the solution jar into which the toothpick is dipped is prone to contamination and spillage. Other solutions to automate the process are complex, expensive and require substantial maintenance. Because of the expense of such machines, their use has generally been limited to larger scale nurseries.

It would be advantageous to provide a device to transfer small seeds.

It would also be advantageous to provide a seed transferring device that is portable.

It would further be advantageous to provide a seed transferring device that is self-contained.

It would further be advantageous to provide a seed transferring device that is easy to use.

It would further be advantageous to provide a seed transferring device that is consistent in operation.

It would further be advantageous to provide a seed transferring device that is inexpensive to construct.

### SUMMARY OF THE INVENTION

In accordance with the present invention, there is provided a manually operated seed transferring device that is portable, self-contained and simple to operate. The device consists of a barrel, a nib holder, and a nib. The barrel is hollow and acts as a reservoir for a liquid such as water. The outside of the barrel is designed to be held comfortably in the fingers. The nib holder is attached to the barrel and is designed to hold the nib securely. The nib is of a material which absorbs liquids such as water which is conveyed from inside the barrel to the nib through capillary action and gravity. If the barrel is flexible then pressure from the fingers to the barrel can convey the liquid. When the moist nib comes into contact with a small seed the small seed is attracted to the nib and can then be transferred from the nib to a wet substrate such as a moist paper towel or moist planting media. The water can be mixed with such things as fertilizer and algaecide.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a plan view of a seed transferring device in accordance with the invention; and

FIG. 2 is a perspective view of a hand operating the seed transferring device picking up a seed and transferring the seed to the growth medium in accordance with the present invention.

For purposes of clarity and brevity, like elements and components will bear the same designations and numbering throughout the Figures.

### DESCRIPTION OF THE PREFERRED EMBODIMENT

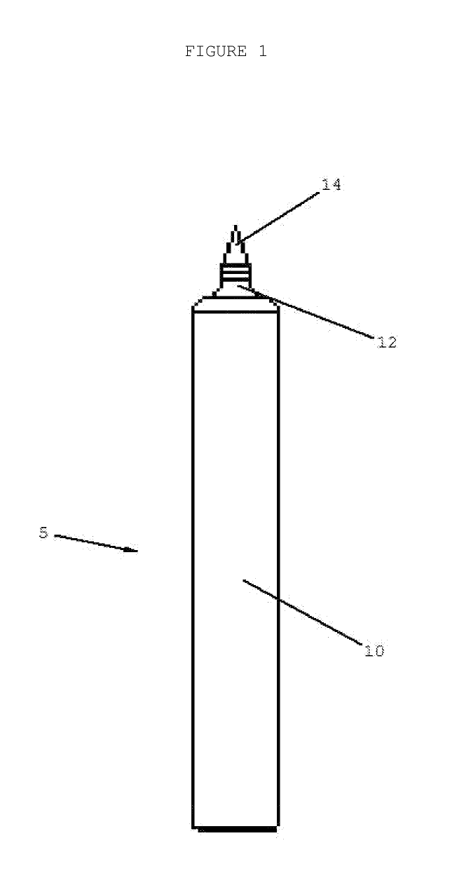

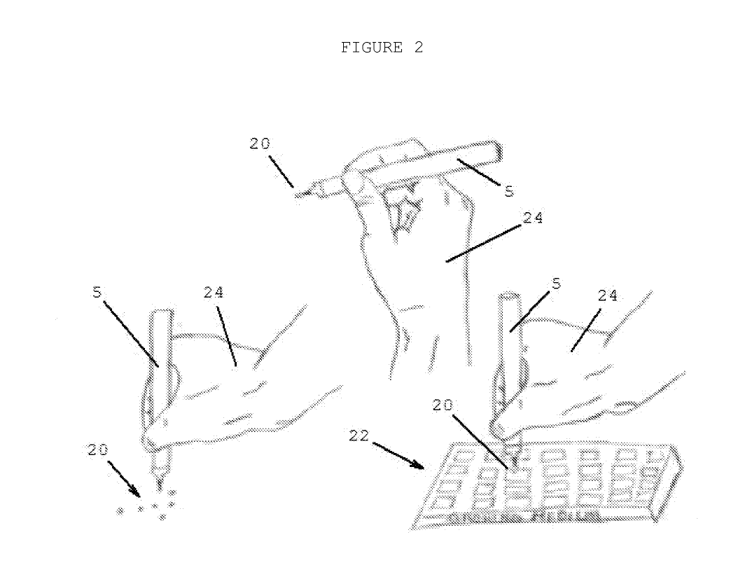

Refer to FIG. 1 and FIG. 2.

FIG. 1 is a plan view of a seed transferring device 5 in accordance with the invention. FIG. 2 is a perspective view of the hand 24 operating the seed transferring device 5. The seed transferring device 5 is designed to use the cohesion and surface tension properties of water to pick up and transfer a seed 20 or a small part. After the nib 14 has been made moist the nib 14 can pick up a seed 20 and transfer it to a moist surface or moist planting medium. The barrel 10 provides a way for the user to grip the seed transferring device 5, provides a reservoir for water and provides a connection for the nib holder 12. One end of the barrel 10 houses the nib holder 12 while the other end may be closed. Either end of the barrel 10 may be used as a port to receive water if the invention is designed to be refillable. The nib holder 12 can be molded into the barrel 10 or attached to the barrel 10 in any number of ways such as a pressed fit, threaded on the barrel 10, glued on the barrel 10 or any number of ways known by those learned in the art. The nib holder 12 is designed to firmly hold the nib 14 in place while still allowing water to seep up into the nib 14 through capillary action, gravity and pressure. If the barrel 10 is made flexible the fingers may be used to compress the barrel 10 forcing the liquid into the nib 14. If the barrel 10 is stiff and compression is not possible the liquid can still flow through the nib 14 by gravity and capillary action. The nib 14 should be porous enough to absorb liquid, but not so porous as to allow liquid to pour out. After the nib 14 becomes moist it is guided to the selected seed 20 by the user. The seed 20 attaches to the moist nib 14 and the user can then transfer the seed 20 by touching the seed 20 to a surface that is wetter than the nib 14. It is well known in the art that the seed 20 will attach itself to the place where the moisture is most abundant. The preferred liquid is water, but it can be mixed with nutrients, fungicides, inoculate, algaecide or any other appropriate substance the user desires.

Specifically FIG. 2 shows how to operate the seed transferring device 5 picking up a seed 20 and transferring the seed 20 to the growth medium in accordance with the present invention. The barrel 10 of the seed transferring device 5 has already been filled with water or similar liquid which has been partially absorbed by the nib 14 making the nib 14 moist. The hand 24 guides the seed transferring device 5 causing the moist nib 14 to come into contact with a single seed 20. Since the moist nib 14 is wetter than the surface the seed 20 rests on, the seed 20 adheres to the moist nib 14. The seed 20 which has become attached to the nib 14 can then be deposited onto a moist growing medium 22 or anything else such as a moist paper towel as long as it is wetter than the nib 14. This property of water is well known to those learned in the art.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A manually operated seed transferring device for picking up a single seed and depositing it in a moist growth media, comprising:
means for providing a reservoir and providing a handle to be grasped by the user;
means for providing a way to secure the nib to the barrel, which is rigidly connected to said means for providing a reservoir and providing a handle to be grasped by the user;
means for providing a conduit for liquid to flow through thus providing a moist surface for the seed to adhere to, frictionally retained to said means for providing a way to secure the nib to the barrel; and
means for picking up seeds or small parts then transferring the seeds or small parts which is self-contained.

2. The manually operated seed transferring device in accordance with claim 1, wherein said means for providing a reservoir with handle to be grasped by the user comprises a hollow barrel.

3. The manually operated seed transferring device in accordance with claim 1, wherein said means for providing a way to secure the nib to the barrel comprises a secure nib holder.

4. The manually operated seed transferring device in accordance with claim 1, wherein said means for providing a conduit for liquid to flow through which provides a moist surface for the seed to adhere to comprises a porous nib.

5. The manually operated seed transferring device in accordance with claim 1, wherein said means for picking up seeds or small parts and transferring the seeds or small parts that is self-contained comprises a portable, functional seed transferring device.

6. A manually operated seed transferring device for picking up a single seed and depositing it in a moist growth media, comprising:
a hollow barrel, for providing a reservoir and providing a handle to be grasped by the user;
a secure nib holder, for providing a way to secure the nib to the barrel, rigidly connected to said barrel;
a porous nib, for providing a conduit for liquid to flow through which provides a moist surface for the seed to adhere to, frictionally retained to said nib holder; and
a portable, functional seed transferring device, for picking up seeds or small parts and transferring the seeds or small parts which is self-contained.

7. The manually operated seed transferring device as recited in claim 6, wherein said barrel has characteristics selected from the following group: plastic, metal, rigid, and flexible.

8. The manually operated seed transferring device as recited in claim 6, wherein said nib has characteristics selected from the following group: felt, and plastic.

9. A manually operated seed transferring device for picking up a single seed and depositing it in a moist growth media, comprising:
a hollow, plastic, metal, rigid, flexible barrel, for providing a reservoir and a handle to be grasped by the user;
a secure nib holder, for providing a way to secure the nib to the barrel, rigidly connected to said barrel;
a porous, felt, plastic nib, for providing a conduit for liquid to flow through which provides a moist surface for the seed to adhere to, frictionally retained to said nib holder; and
a portable, functional seed transferring device, for picking up seeds or small parts and transferring the seeds or small parts which is self-contained.

10. A method for picking up seeds or small parts one at a time and transferring them to a moist growth media or a moist surface using a seed transferring device consisting of a barrel, nib holder and a nib.
